(19) United States
(12) Patent Application Publication
(10) Pub. No.: US 2006/0025958 A1
(43) Pub. Date: Feb. 2, 2006

(54) Self-adaptive vehicle speed detecting device

(76) Inventor: Shih-Hsiung Li, Taipei (TW)

Correspondence Address: DELLETT & WALTERS, P. O. BOX 82788, PORTLAND, OR, 97282-0788, US

(21) Appl. No.: 10/910,967

(22) Filed: Aug. 2, 2004

(51) Int. Cl. G01P 11/00

(52) U.S. Cl. 702/142

(57) ABSTRACT

A self-adaptive vehicle speed detecting device has a microprocessor, an input unit and a memory. When setting commands are input to the microprocessor through the input unit, the microprocessor fetches a pulse signal from a vehicle speed sensor as a vehicle speed threshold value. After the threshold value setting, the microprocessor continuously fetches the pulse signal representing a current speed when the vehicle is moving. The pulse signal is compared with the speed threshold value. When the current speed is slower than the threshold value, the microprocessor generates a control signal to driver other devices such as an obstacle detecting sensor.

### BACKGROUND OF THE INVENTION

1. Field of the Invention

The present invention relates to a self-adaptive vehicle speed detecting device, and more particularly to a vehicle speed detecting device that presets a speed threshold value based on a speed signal generated by a vehicle itself, and compares a detected current vehicle speed with the threshold value whereby when the current speed is below the threshold value, the speed detecting device can accordingly produce a control signal to drive other elements such as an obstacle detecting radar.

2. Description of Related Art

Nowadays, obstacle detecting sensors have become standard equipment for most cars to assist drivers especially when parking a vehicle. The obstacle detecting sensors, which are mounted at a front portion of the vehicle, can be activated when the vehicle speed is lower than a pre-determined threshold value to detect whether any obstacle exists in front of the vehicle. Therefore, a vehicle speed sensor (VSS) is expected to generate a control signal to active these sensors.

The already existing VSS installed in the vehicle can generate a pulse signal standing for a detected current speed value. The frequency, as well as the pulse width of the pulse signals, is varied with different speed values. The pulse signal is furnished to control a vehicle speed meter thus showing drivers the present speed. Further, if the current vehicle speed is intended to be applied in other applications, the pulse signal may be useful. However, for different vehicles, even when the vehicles are driven at the same moving speed, the frequency and pulse width of the pulse signals are still different because of the variety of vehicle types.

Therefore, for a device that utilizes the pulse signal and is intended to be widely applied to multiple kinds of vehicles, the device must possess an ability to adapt these vehicles. A DIP switch can be applied in the device to select a proper algorithm for analyzing a corresponding kind of pulse signal. For example, for a 10 bit DIP switch, the switch is able to select an algorithm from 1024 (2¹⁰=1024) kinds of algorithms just by setting each bit to one or zero. Each algorithm, corresponding to a particular type of vehicles, is pre-established based on the detected frequency and the pulse width of the pulse signal. However, when establishing the algorithms, car manufacturers must precisely detect and calculate the pulse signal of all kinds of vehicles. Such a procedure is quite complex.

To overcome the shortcomings, the present invention tends to provide a self-adaptive vehicle speed detecting device to mitigate or obviate the aforementioned problems.

### SUMMARY OF THE INVENTION

An objective of the invention is to provide a self-adaptive vehicle speed detecting device in which a threshold value is established based on a pulse signal generated by a VSS of a vehicle thus simplifying the threshold value setting process.

The speed detecting device comprises:
a microprocessor receiving a pulse signal generated from the vehicle speed sensor, wherein the pulse signal represents a current vehicle speed;
an input unit coupled to the microprocessor to receive setting commands input from a user; and
a memory coupled to the microprocessor and storing a speed threshold value;
wherein the self-adaptive vehicle speed detecting device has a setting mode and an operating mode, in the setting mode a pulse signal generated by the VSS representing a desired vehicle speed is fetched as the speed threshold value, and in the operating mode the microprocessor continuously fetches the pulse signal representing a current vehicle speed from the VSS and compares with the speed threshold value, based on the comparison result the microprocessor generates a control command.

Other objects, advantages and novel features of the invention will become more apparent from the following detailed description when taken in conjunction with the accompanying drawings.

### BRIEF DESCRIPTION OF THE DRAWINGS

FIG. 1 is a block diagram of a self-adaptive vehicle speed detecting device in accordance with the present invention; and

FIG. 2 is a block diagram showing the self-adaptive vehicle speed device in FIG. 1 is operated in coordination with an obstacle detecting sensor.

### DETAILED DESCRIPTION OF PREFERRED EMBODIMENT

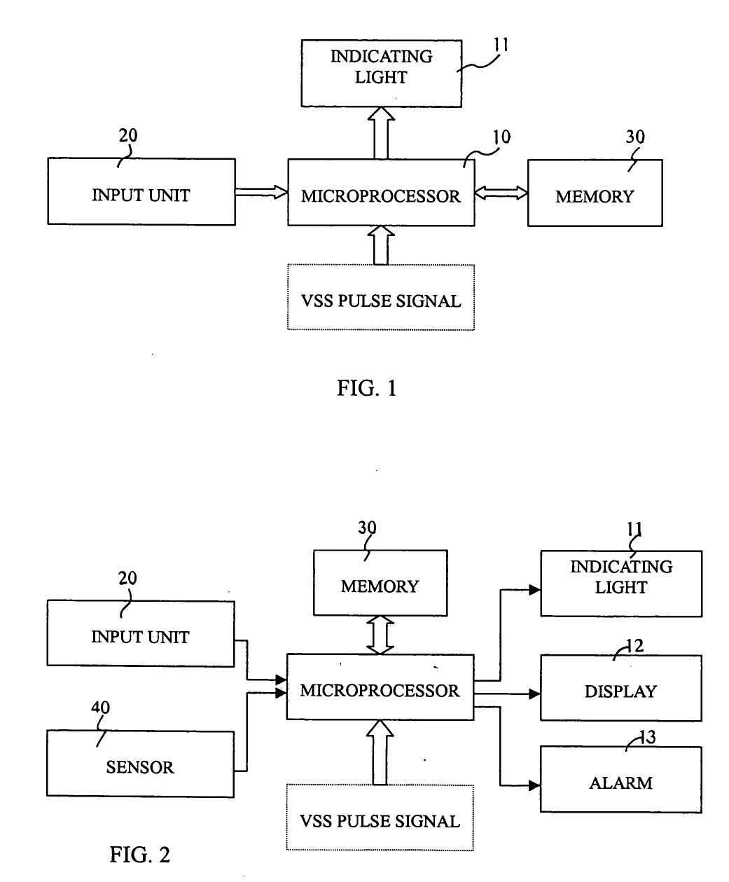

With reference to FIG. 1, a self-adaptive vehicle speed detecting device in accordance with the present invention comprises a microprocessor (10), an input unit (20), a memory (30) and an optional indicating light (11).

The microprocessor (10) receives a pulse signal generated from a vehicle speed sensor (VSS, not shown) installed in a vehicle.

The input unit (20) coupled to the microprocessor (10) can be composed of a button or a key set through which a user can input control commands.

The memory (30) is coupled to the microprocessor (30) and stores at least one preset speed threshold value. The memory (30) is preferably performed by an electrically erasable programmable read-only memory (EEPROM), a flash memory or a non-volatile memory so that even when the electricity supply is interrupted, the data still can be safely stored.

The indicating light (11) is provided to show operations status of the self-adaptive vehicle speed detecting device.

Based on the foregoing configuration, the microprocessor (10) continuously receives the pulse signals generated from the VSS and compares a currently detected pulse signal with the speed threshold value. The operation of the self-adaptive vehicle speed detecting device includes two modes, a setting mode and an operating mode.

Before using the self-adaptive vehicle speed detecting device, threshold values are set in the device through the setting mode. In more detail, a speed value is fetched and stored in the memory (30) for subsequent comparison processes. When the vehicle is started up and accelerated to a desired speed, a user can input commands through the input unit (20) to fetch the pulse signal generated by the VSS representing the desired speed value and store the fetched signal into the memory (30). The foregoing process may be repeated to set multiple threshold values representing different speeds for different applications.

When finishing the threshold value setting, the self-adaptive vehicle speed detecting device works in the operating mode. The microprocessor (10) continuously fetches a pulse signal that represents the current vehicle speed. The fetched pulse signal is then compared with the threshold value. If the current vehicle speed is greater than the threshold value, the microprocessor (10) will not output any control commands. However, when the current vehicle speed is lower than the threshold value, the microprocessor (10) generates a control command to drive other devices that are operated in response to the change of the vehicle speed.

With reference to FIG. 2, the self-adaptive vehicle speed detecting device is applied to activate an obstacle detecting sensor (40), and more especially such a sensor is installed in a front portion of the vehicle. The detecting sensor can be preferably implemented by an ultrasonic sensor, a microwave sensor, an infrared sensor or an image capturing device. The microprocessor further connects to a display (12) and alarm (13). The display (12) can show a calculated distance value between the vehicle and a detected obstacle to the driver. The alarm (13) can produce a warning signal to alert the driver the vehicle is too close to the obstacle. As an example, the preset threshold value is 5 km/hour. Therefore, when the vehicle speed is slower than the threshold value, the microprocessor (10) will generate a control command to activate the obstacle detecting sensor.

Through the use of the self-adaptive vehicle speed detecting device in accordance with the present invention, the threshold value is established based on the pulse signal generated by the VSS of the vehicle itself.

Even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A self-adaptive vehicle speed detecting device installed in vehicle having a vehicle speed sensor (VSS), the vehicle speed detecting device comprising:
a microprocessor receiving a pulse signal generated from the vehicle speed sensor, wherein the pulse signal represents a current vehicle speed;
an input unit coupled to the microprocessor to receive setting commands input from a user; and
a memory coupled to the microprocessor and storing a speed threshold value;
wherein the self-adaptive vehicle speed detecting device has a setting mode and an operating mode, in the setting mode a pulse signal generated by the VSS representing a desired vehicle speed is fetched as the speed threshold value, and in the operating mode the microprocessor continuously fetches the pulse signal representing a current vehicle speed from the VSS and compares with the speed threshold value, based on the comparison result the microprocessor generates a control command.

2. The self-adaptive vehicle speed detecting device as claimed in claim 1, wherein the microprocessor further connects to an obstacle detecting sensor, and the obstacle detecting sensor is activated when the current vehicle speed is slower than the threshold value.

3. The self-adaptive vehicle speed detecting device as claimed in claim 2, the obstacle detecting sensor is implemented by an ultrasonic sensor, a microwave sensor, an infrared sensor or an image capturing device.

4. The self-adaptive vehicle speed detecting device as claimed in claim 1, the input unit is a button.

5. The self-adaptive vehicle speed detecting device as claimed in claim 1, the input unit is a key set.

6. The self-adaptive vehicle speed detecting device as claimed in claim 1, the memory is implemented by an electrically erasable programmable read-only memory (EEPROM), a flash memory or a non-volatile memory.

7. The self-adaptive vehicle speed detecting device as claimed in claim 1, the microprocessor further connecting to an indicating light showing operation status of the self-adaptive vehicle speed detecting device.

8. The self-adaptive vehicle speed detecting device as claimed in claim 6, the microprocessor further connecting to an indicating light showing operation status of the self-adaptive vehicle speed detecting device.

9. The self-adaptive vehicle speed detecting device as claimed in claim 6, the microprocessor further connecting to an alarm to issue a warning signal.
